(19) United States
(12) Patent Application Publication
(10) Pub. No.: US 2005/0281541 A1
(43) Pub. Date: Dec. 22, 2005

(54) Image organization method and system

(76) Inventors: Beth Teresa Logan, Cambridge, MA (US); David Mark Frohlich, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/869,095

(22) Filed: Jun. 17, 2004

(51) Int. Cl. H04N 5/76

(52) U.S. Cl. 386/96; 386/97

(57) ABSTRACT

A method for organizing images in disclosed. The method includes associating audio clips to digital images and storing the digital images. The method also includes specifying criteria for retrieval of images from the stored digital images. Digital images satisfying the specified criteria are retrieved from the stored digital images and sorted based on proximity of the audio clips associated with the retrieved images to the specified criteria.

### BACKGROUND

Digital photography is well known. Affordability of this technology has lead to increased usage resulting in an increase in the number of digital images (which may also be referred to as digital pictures or digital photos) in one's collection or possession. Digital images are typically stored in an archival medium such as a computer memory, compact disc or the like.

Organization of digital images for easy retrieval and/or presentation is highly desirable. Digital images typically contain information such as the date and time of creation (of the image) similar to other electronic files such as word processing documents, spread sheets and electronic mail messages. Digital images may be organized according to this date for example. Using the date as a criterion, digital images may be organized in a chronological or a reverse chronological order.

Other retrieval techniques are based on determining image similarity or by analyzing semantic annotations such as text or speech associated with the images.

In retrieval based on image similarity, a sample image is selected. Other images having similar features as the sample image, such as color and texture, are retrieved. Such methods, however, lack semantic analysis. Other approaches involving semantic analysis of images have not been precise.

Retrieval techniques based on annotation use either text associated with an image or convert other annotations (e.g. speech) to text. Text retrieval techniques are then used to select one or more similar images. Such systems are limited by content of the annotations which are often inadequate.

Current technology also facilitates the association of audio clips to digital images which, as mentioned above, may also be referred to as digital pictures or digital photos. Such digital images with associated audio clips may be referred to as audio photos. Audio clips can include a song, instrumental music (i.e. without lyrics), speech or ambient noise.

At least some embodiments provide improved methods and apparatus for organizing digital images.

### SUMMARY

In one aspect, an image retrieval method is disclosed. The method includes associating an audio clip to each of a plurality of digital images and storing the digital images. The method also includes specifying criteria for retrieval of images and retrieving all images satisfying the specified criteria.

In another aspect, an image organization method is disclosed. The method includes associating an audio clip to each of a plurality of digital images and storing the digital images. The method also includes specifying criteria for retrieval of images, retrieving all images satisfying the specified criteria and sorting the retrieved images based on proximity of the audio clips associated with the retrieved images to the specified criteria.

In a further aspect, a system for organizing images is disclosed. The system includes a means for associating an audio clip to each of a plurality of digital images, a means for storing the digital images and a means for specifying criteria for retrieving the images. The system also includes a means for retrieving images satisfying the specified criteria and a means for sorting the retrieved images based on a relationship of the audio clip associated with the retrieved image to the specified criteria.

### BRIEF DESCRIPTION OF THE DRAWINGS

The accompanying drawings, which are incorporated in and constitute a part of the specification, illustrate an embodiment of the invention and, together with the description, explain the invention. In the drawings,

FIGS. 1A-1A illustrate digital photos containing audio clips;

FIG. 2 illustrates a method in accordance with an exemplary embodiment for retrieving digital photos containing audio clips;

FIGS. 3A and 3B illustrate retrieval and organization results in accordance with exemplary embodiments;

FIG. 4 illustrates a method in accordance with another exemplary embodiment for organizing digital photos containing audio clips; and

FIG. 5 illustrates a system in accordance with exemplary embodiments.

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

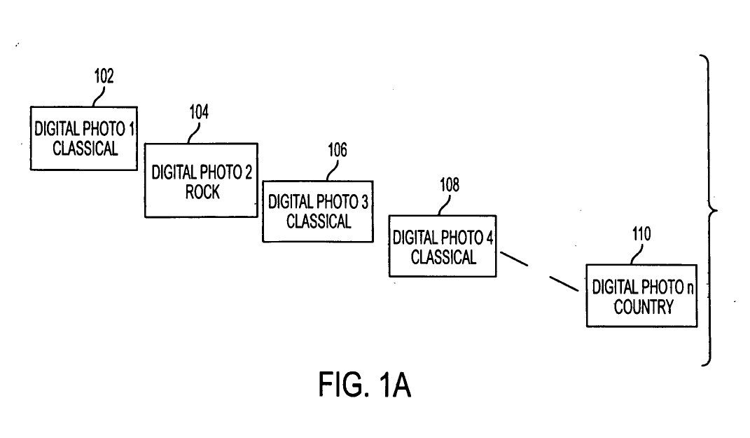

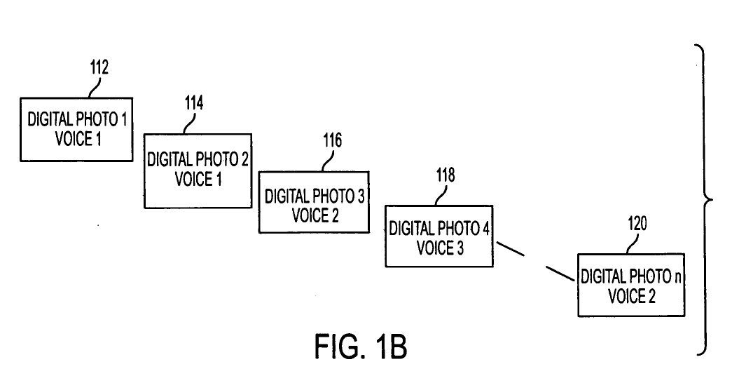

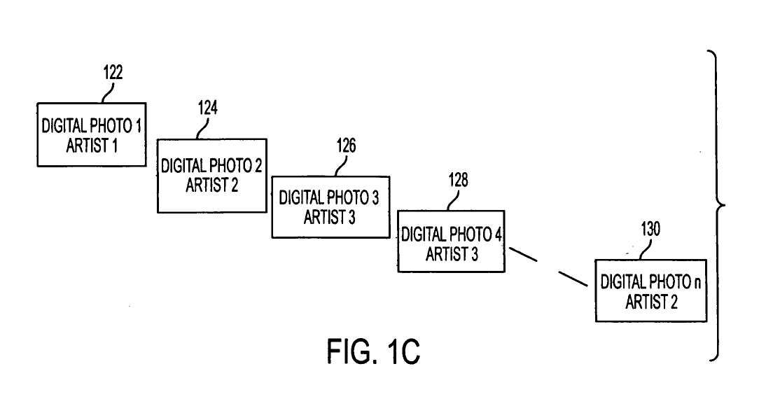

In exemplary embodiments, digital photos (or digital images) may be arranged according to audio clips associated with the photos. Digital photos containing audio clips may be referred to as audio photos. An audio clip may be a song, a part of a song, a classical composition such as Beethoven's 5^{th} symphony, an instrumental musical composition (i.e. without lyrics), a voice (such as speech) or an ambient noise. A voice may be someone commenting on a particular digital photo and an ambient noise may be the sound of the rustling of leaves or the sound of a water fall for example. An audio clip may also be a type of music such as classical or rock for example. A particular audio clip such as the “happy birthday” tune may be associated with digital photos from a birthday party for example. Digital photos from an outing in nature may be associated with classical music for example. As illustrated in FIG. 1A, each of digital photos 102-110 may be associated with different types of music such as classical, rock and country for example. Digital photos of a particular individual (i.e., where the individual is the subject of the digital photo) may be associated with voice of that individual or by the individual's favorite artist for example. FIGS. 1B and 1C illustrate digital photos 112-120 associated with voices 1-3 and digital photos 122-130 associated with songs by artists 1-3 for example.

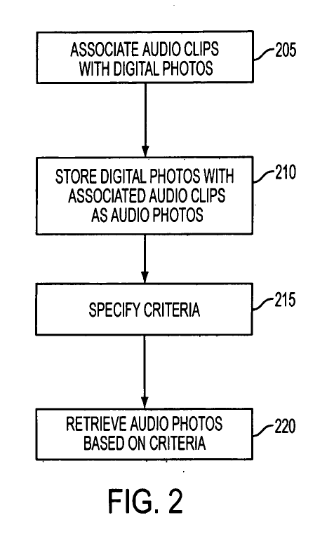

An exemplary method for retrieving audio photos may be described with reference to FIG. 2. An audio clip may be associated with a digital photo at step 205. A digital photo with the associated audio clip may be stored or archived (on a computer memory for example) as an audio photo at step 210. A criterion for retrieving audio photos may be specified at step 215. A type of music, such as “classical” may be specified as the criterion for example. Profiles of different audio clips (including classical music in this example) may be pre-stored at a remote location. The remote location may be accessible over a network such as the internet for example. In the example of classical music being specified as the criterion, the profile for classical music may be retrieved from the remote location. This profile (i.e. retrieved from the remote location) may be used to retrieve stored audio photos having similar audio clips associated therewith at step 220. That is, all stored audio photos containing classical music may be retrieved in this example.

In exemplary embodiments, the retrieval may be based on audio similarity. Audio similarity may be determined utilizing methods described in commonly assigned co-pending U.S. Patent Application Publication No. U.S. 2002/0181711 A1 (by Beth Logan, co-inventor of the present application and Ariel Solomon) dated Dec. 5, 2002 and titled “Music Similarity Function Based On Signal Analysis”, the subject matter of which is incorporated herein by reference.

As described in the co-pending Application, instrumentation information and beat information may be captured for an audio clip (referred to as musical composition in the co-pending application). Spectral based distance measure may be used to capture the instrumentation information and a rhythmic-based measure may be used to capture the beat information. The spectral and beat information may determine a profile or a signature for an audio clip. The spectral signature and beat signature between audio clips may be compared to determine similarity between the audio clips. Samples of audio clips with associated profiles may be pre-stored by category or artist at one or more remote locations accessible over a network for example.

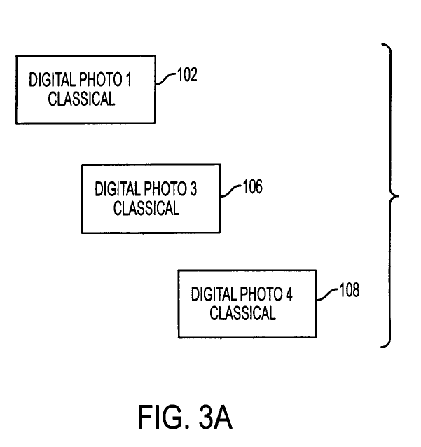

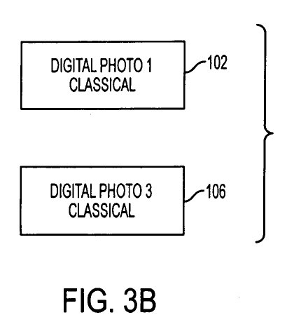

Audio photos with classical music may be retrieved in this example. As illustrated in FIG. 3A, digital photos 102, 106 and 108 of FIG. 1A may be retrieved since classical music is associated with each of these digital photos.

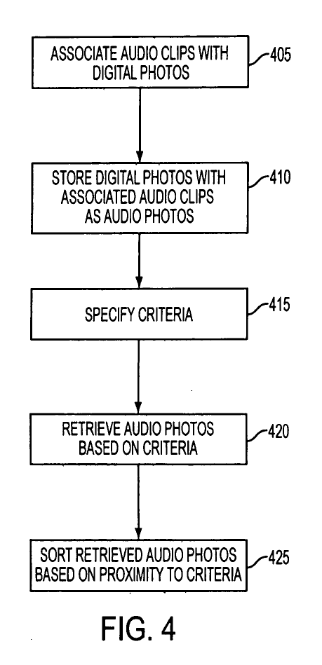

In other embodiments, retrieved audio photos may also be organized based on their audio similarity to the specified criteria. This is illustrated in FIG. 4 at step 425 (steps 405-420 correspond to steps 205-220 of FIG. 2). The similarity may be determined by comparing the (audio) profile obtained from the remote location to the audio clip associated with the retrieved audio photo.

In organizing retrieved audio photos, those photos with audio clips that are closer, in terms of musical similarity or spectral distance as described in the co-pending application, to the retrieved profile may be placed before photos with audio clips that are farther from the retrieved profile. This order may be reversed as well—that is, audio photos that are farther from the specified criteria may be placed before audio photos that are closer to the specified criteria.

In exemplary embodiments, a profile may be determined for audio clips associated with the digital photos as well. Upon specifying the criterion, a profile for the specified criterion (classical in this example) may be retrieved from the remote location as described. This (retrieved) profile may be compared with the profiles of the audio clips associated with the digital photos to determine musical similarity.

In other embodiments, additional criterion may be specified. These may include a number of audio photos that are to be retrieved and/or organized. The number of photos retrieved using this criterion may be based on selecting those having the strongest audio similarity. As illustrated in FIG. 3B, for example, if the number specified is two, then only digital photos 102 and 106 may be retrieved for display or to form a slide show (assuming that photos 102 and 106 are closer to the specified criteria than photo 104). Other criterion may include choosing only photos within a predetermined musical distance of the first retrieved photo. Musical distance may be determined based on musical similarity as described in the co-pending application.

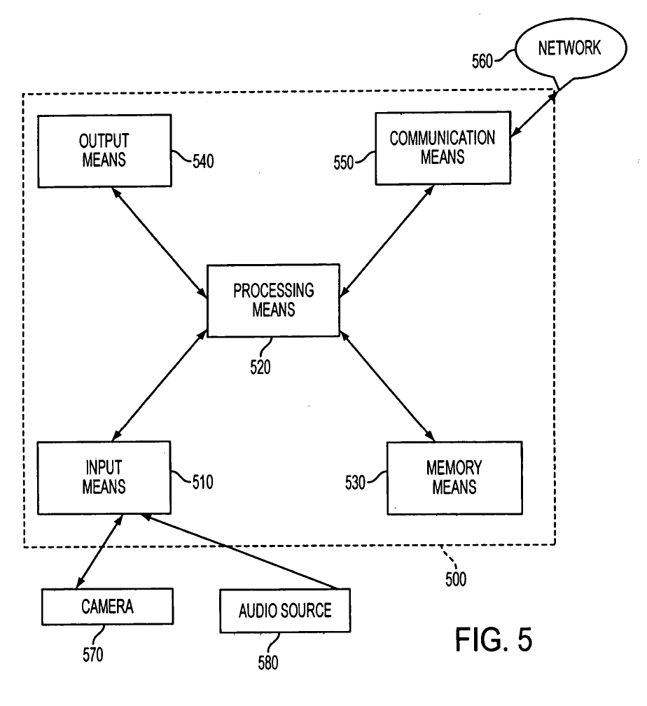

In exemplary embodiments, the methods described may be implemented on a computer such as computer 500 illustrated in FIG. 5. Computer 500 may be a handheld computer, a laptop computer, a desktop computer or the like. Computer 500 may include an input means 510, a processing means 520, a memory means 530, an output means 540 and a communication means 550. A plurality of digital photos may be received by computer 500 via communication means 550 over a network 560 for example. Communication means 550 may be a modem and network 560 may be the internet for example.

The digital photos may also be received via input means 510 from a device such as a digital camera 570 for example. Input means 510 may be a mouse, a keyboard or a voice recognition module. In exemplary embodiments, other devices may include a scanner or a facsimile machine. Traditional photos (in the form of photos on a photo paper for example) developed from a photographic film may be scanned in via the scanner and converted into digital photos. The digital photos may be stored in memory means 530.

Profiles for audio clips may be stored in memory means 530 or at an external (or remote) location that is accessible through communication means 550 over network 560. Audio clips may be received from an audio source 580. The audio clips may be associated with the digital photos by processor 520. Criteria for retrieval and/or organization may be specified via input means 510. The comparison between the profile (based on specified criteria) and the audio clips associated with the digital photos may be performed by processor 520.

Memory means 530 may also include a set of instructions or an algorithm for implementing the exemplary methods described. The instructions or algorithm, when executed by processing means 520, may result in the retrieval of audio photos based on the specified criteria. In alternative embodiments, the instructions may also result in sorting of the retrieved photos. The retrieved and/or sorted photos may also be stored in memory means 530. The photos may be communicated via communication means 550 or by output means 540. Output means 540 may be a printer or a display for example.

In alternative embodiments, audio clips may include a combination of music and speech (also referred to as a voiceover) or music and ambient noise. Voiceovers and ambient noise may also be processed in accordance with the methods described in the co-pending application.

If a voiceover is associated with a digital photo in addition to or in place of music, the voiceover may be converted to text using known speech recognition techniques and semantic analysis may be used to determine semantic similarity between voiceovers.

While the embodiments have been described with respect to a type (or genre) of music such as classical, other categories such as an artist, a period (such 1970s music), a particular rhythm and the like may also be used.

Furthermore, a method in accordance with exemplary embodiments may also include a user selecting an audio photo as the starting point. In this scenario, a profile for the audio clip associated with the selected starting photo may be determined. This profile may then be used to retrieve other digital photos having similar music associated therewith.

In the description of exemplary embodiments, the terms ‘digital images’ may be synonymous with ‘digital pictures’, ‘digital photos’ or ‘audio photos’ if audio clips are associated with the digital photos. Similarly, the term ‘speech’ may be synonymous with ‘voiceover’. The terms ‘musical composition’ may be synonymous with ‘song’, ‘symphonic composition’ and ‘instrumental musical composition’.

The foregoing description of exemplary embodiments of the present invention provides illustration and description, but it is not intended to be exhaustive or to limit the invention to the precise form disclosed. Modifications and variations are possible in light of the above teachings or may be acquired from practice of the invention.

The following claims and their equivalents define the scope of the invention.

1. An image retrieval method comprising the steps of:
associating audio clips to a plurality of digital images;
storing the digital images;
specifying criteria for retrieval of the stored images; and
retrieving images satisfying the specified criteria from said stored images.

2. The method of claim 1, wherein the audio clip comprises at least a portion of a song.

3. The method of claim 1, wherein the audio clip comprises at least a portion of an instrumental musical composition.

4. The method of claim 1, wherein the audio clip comprises speech.

5. The method of claim 4 further comprising:
converting the speech to text via a speech recognition process.

6. The method of claim 1, wherein said criteria includes a number of images for retrieval.

7. The method of claim 1, wherein said criteria includes a musical distance.

8. The method of claim 1, wherein images are retrieved based on comparing the specified criteria to audio clips associated with each of the digital images.

9. An image organization method comprising:
associating audio clips to a plurality of digital images;
storing said digital images;
specifying criteria for retrieval of the stored digital images;
retrieving images satisfying the specified criteria from said stored digital images; and
sorting the retrieved images based on proximity of the audio clips associated with the retrieved images to the specified criteria.

10. The method of claim 9, wherein the audio clip is at least a portion of a song.

11. The method of claim 10, wherein the criteria specifies a musical type.

12. The method of claim 11, wherein profiles for a plurality of audio clips are archived at a remote location.

13. The method of claim 12, wherein each of said profiles is based on spectral and beat information for an audio clip.

14. The method of claim 12, further comprising:
retrieving a profile based on the specified criteria; and
comparing the retrieved profile with audio clips associated with each of the stored digital images.

15. The method of claim 14, further comprising:
determining a profile for audio clips associated with the stored images.

16. The method of claim 15, wherein said sorting is based on determining audio similarity between the profile of the audio clip associated with a retrieved image and the profile retrieved from the remote location and based on the specified criteria.

17. The method of claim 16, wherein said criteria includes a sorting order.

18. The method of claim 16, wherein the retrieved images with audio clips having a greater similarity to the retrieved profile are placed prior to images with audio clips having a lesser similarity to the retrieved profile.

19. The method of claim 9 further comprises creating a slide show from the sorted images.

20. An image organization system comprising:
means for associating audio clips to digital images;
means for storing said digital images;
means for specifying criteria for retrieval of images from said stored digital images;
means for retrieving images satisfying the specified criteria from said stored digital images; and
means for sorting the retrieved images based on proximity of the audio clips associated with the retrieved images to the specified criteria.

21. A computer readable medium containing executable instructions, when executed in a processing system, cause the system to perform a method comprising:
associating audio clips to a plurality of digital images;
storing said digital images;
specifying criteria for retrieval of the stored digital images;
retrieval images satisfying the specified criteria from said stored digital images; and
sorting the retrieved images based on proximity of the audio clips associated with the retrieved images to the specified criteria.
